(19) United States
(12) Patent Application Publication
(10) Pub. No.: US 2025/0124278 A1
(43) Pub. Date: Apr. 17, 2025

(54) ESTIMATOR FOR TRAINING LARGE LANGUAGE MODELS

(71) Applicant: Dell Products L.P., Round Rock, TX (US)

(72) Inventors: Alexander Eulalio Robles Robles, Valinhos (BR); Vicente J.P. Amorim, João Monlevade (BR); Pedro Chem, Porto Alegre (BR)

(21) Appl. No.: 18/488,391

(22) Filed: Oct. 17, 2023

(51) Int. Cl. G06N 3/08; G06N 3/0455

(52) U.S. Cl. CPC G06N 3/08; G06N 3/0455

(57) ABSTRACT

Estimating requirements, including computing resource requirements, time requirements, and cost requirements, for training machine learning models is disclosed. A dataset from a user is explored and prepared for use in training a model. A model is selected based on at least an expected use case for the dataset. Generally, a trained model is selected and the dataset is used to fine-tune the model for the specific use case. After optimizing the model, such as by reducing the number of parameters to be tuned, the requirements are estimated. If approved, a training instance is instantiated and training is performed.

### FIELD OF THE INVENTION

Embodiments of the present invention generally relate to machine learning models including large language models. More particularly, at least some embodiments of the invention relate to systems, hardware, software, computer-readable media, and methods for training machine learning models including large language models.

### BACKGROUND

Large language models are able to perform a variety of natural language related tasks including tasks such as generating text, translating languages, answering queries, and creating code. The changes and growth of large language models, however, is far outpacing Moore's law. The rate of growth has resulted in practical problems. For example, large language models have surpassed the capacity of graphical processing units (GPUs) currently available. In many instances, a single device may not be able to hold a copy of the model's weights. As a result, out of memory (OOM) issues may occur at least when training the model.

The need for memory is a concern even when using large clusters to train the models. When training a model, for example, backpropagation involves creating large matrices for gradients and other relevant quantities for optimizers and network states. Stated from a practical perspective, training large language models requires large amounts of computing resources including GPU memory. Inference operations face similar issues.

To address the problems related to high GPU memory consumption during training and inference, current methods attempt to reduce the amount of GPU memory required by offloading memory components of the model, optimizer states, and gradients to a central processing unit (CPU) and to disk. This allows a large model to be trained or execute using a few GPUs or even a single GPU. However, this uses the available resources inefficiently.

Another issue with large language models is that before a model is trained, it is often necessary to configure multiple parameters, which may require expert knowledge. This process has a steep learning curve and is labor intensive because the user is required to investigate and discover which parameters should be configured to ensure that the model is trained appropriately.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of estimating the computing resources, time, and/or cost to train a machine learning model;

FIG. 2 discloses aspects of a dictionary describing a machine learning model and metadata of the machine learning model;

FIG. 3 discloses additional aspects of the phases performed in estimating the computing resources, time, and/or cost required to train a machine learning model;

FIG. 4 discloses aspects of estimating the computing resources needed to train a machine learning model;

FIG. 5 discloses aspects of automatically configuring a model's parameters;

FIG. 6 discloses aspects of experimental results including telemetry data in estimating at least computing resources for training a machine learning model; and

FIG. 7 discloses aspects of a computing device, system, or entity.

### DETAILED DESCRIPTION OF SOME EXAMPLE EMBODIMENTS

Embodiments of the present invention generally relate to machine learning models, training machine learning models, estimating aspects of training machine learning models, and/or executing machine learning models. More particularly, at least some embodiments of the invention relate to systems, hardware, software, computer-readable media, and methods for estimating computational resources, time, and/or cost required for training and/or fine-tuning machine learning models including large language models (LLMs).

Example LLMs may include OpenAI's GPT-3 (Generative Pre-trained Transformer), Google's BERT (Bidirectional Encoder Representations from Transformers), and Meta's ROBERTa (Robustly Optimized BERT Pre-training Approach). These models have been trained on very large datasets of text and are identified by way of example only. Other LLMs are available and benefit from embodiments of the invention.

Low-Rank Adaptation (LoRA), with regard to large language models, refers to a technique used to adapt pre-trained language models to new domains or tasks by exploiting the low-rank structure of the model's weight matrices. LoRA reduces the computational complexity of fine-tuning by approximating the model's weight matrices with low-rank matrices. This may be achieved by decomposing the original weight matrices into two smaller matrices of lower rank. The low-rank matrices can be updated more efficiently during fine-tuning. This may lead to faster convergence and improved performance on the new task for which the model is being fine-tuned.

Embodiments of the invention generally relate to an estimation engine that is configured to estimate the computational resources required for training machine learning models, the time required to train the machine learning models, and the cost of training the machine learning models. Embodiments of the invention are discussed with respect to LLMs, but are applicable to other machine learning model types and categories. Embodiments of the invention may be applied to both training and operational aspects (inference operations) of machine learning models.

Models such as LLMs require substantial computing resources (e.g., GPUs, CPUs) because LLMs may have billions or even trillions of parameters. Even when an LLM is being fine-tuned, several GPUs may be needed. Embodiments of the invention provide for estimating the training requirements at least in terms of computing resources, time, and/or cost.

As discussed in more detail herein, embodiments of the invention relate to training a model from scratch (no prior training), fine-tuning a model that has been previously trained, and/or fine-tuning a model that has been previously trained with optimizations (e.g., parameter reduction, automatic configuration).

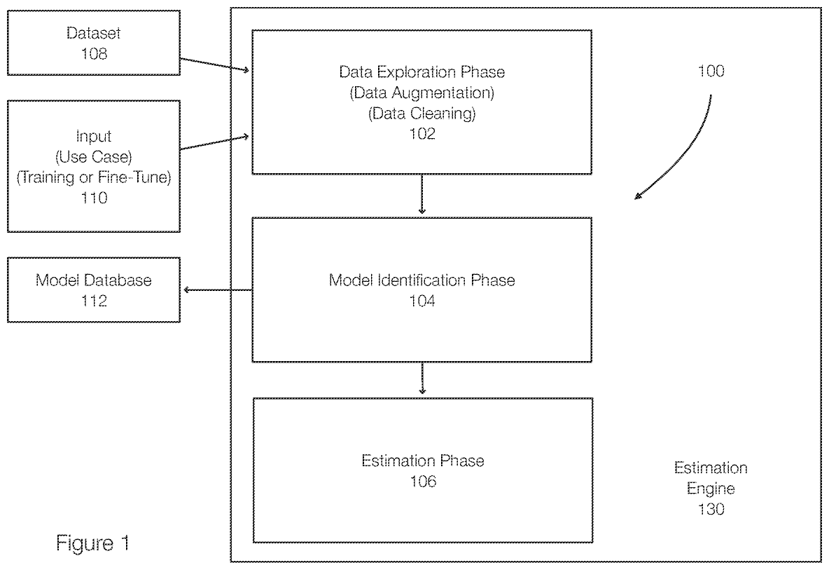

FIG. 1 discloses aspects of estimating the training requirements of a machine learning model such as an LLM. The task of estimating the training requirements may be performed by an estimation engine 130 in phases 100. The phases 100 include a data exploration phase 102. Generally, the data exploration phase 102 includes receiving a dataset 108 that will be used to train a model or fine-tune an already trained model for a specified task. Other input 110, such as a use case and a type of training to be performed, may also be received.

More specifically, a user provides the dataset 108 and identifies whether the dataset 108 will be used to fully train a model or fine-tune a pre-trained model. In many examples, the cost and resources required to fully train a one billion, ten billion, one hundred billion parameter (or more) model is very costly. As a result, embodiments of the invention may recommend fine-tuning a pre-trained model for its downstream application or specified use case.

The data exploration phase 102 may explore the dataset 108 and perform various operations that may allow the dataset 108 to be better understood. For example, assuming that the dataset 108 is a text dataset, the number of unique words and tokens may be determined.

The estimation engine 130, which may be performing the phases 100, may perform preparation operations during the data exploration phase 102 to enrich the dataset 108. Examples of preparation operations include data augmentation operations and data cleaning operations.

Augmentation operations may include generating new data points in the dataset space. Data augmentation may increase the amount of data by generating new data from the existing data. This may include minor changes, or new data. Augmenting the dataset 108 may increase the diversity of the training dataset 108. The cleaning operation may be performed on the dataset 108 (or the augmented dataset). The cleaning operation may remove unwanted characters, identify and remove errors in the dataset 108, or the like. Data exploration ensures that the dataset 108 is suitably configured for training purposes.

Once the data exploration phase 102 is completed, a model identification phase 104 may be performed. Using the specific use case received in the input 110, the estimation engine 130 may search a model database 112 to retrieve or identify a model for the use case. For example, during the model identification phase 104, the estimation engine 130 may identify BERT for a question/answer use case, GPT for a text generation use case, T5/OPT for fine-tuning and few shot prompting use case, or the like.

In one example, the model identification phase 104 generates or retrieves a dictionary from the model database 112 that has information of the identified model. An example output or dictionary may be:
Bert={hd, seq, tok, etc}, where
   hd=hidden layer dimension,
   seq=sequence length, and
   tok=tokenizer.

The dataset 108, which was previously explored and/or prepared, is tokenized with the tokenizer associated with the selected or identified model.

More specifically, the model identification phase 104 may recommend a model to a user based on the specific task or application provided by the user. When the dataset 108 is to be used to train an LLM to generate text, the estimation engine 130 may recommend the GPT model during the model identification phase 103. The database 112 may associated various models with certain tasks such that specific models can be recommended for the user's use case.

The model database 112 may store data representing a number of different models (e.g., LLMs) and their metadata. For example, the metadata of a particular model may include information such as the number of hidden layers, historical batch size training, model size, recommended natural language processing task, the tokenizer associated with the model or the like.

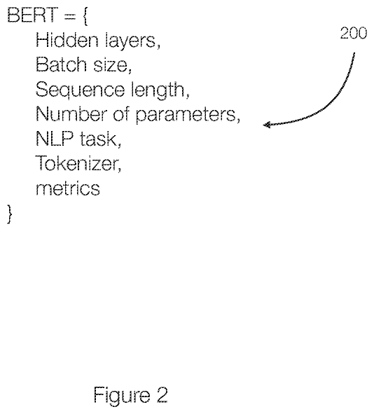

FIG. 2 discloses aspects of information, including metadata, that may be stored in the database 112 for each model. Example metadata 200 for a model such as BERT is illustrated.

The database 112 may also store telemetry data that was obtained during a fine-tuning process (e.g., a previously performed fine-tuning process). The telemetry data and the previously estimation generated by the estimation engine 130 can be used to continually improve the operation of the estimation engine 130.

After the model identification phase 104, the estimation phase 106 may be performed or executed by the estimation engine 130. In the estimation phase 106, the number of parameters and tokens, which are reduced or minimized in one example and which were obtained during the model identification phase 104, are determined. This determination may be performed using approaches such as LoRA, Few-Shot Parameter-Efficient Fine-Tuning, or the like. These estimations or optimizations attempt to decrease the number of parameters that will be fine-tuned without losing accuracy. This is a trade-off between good performance and minimizing the parameters that need to be trained.

Next, the computational resource, time, and cost are estimated or determined using the number of tokens and parameters that have been determined. The number of parameters allows the number of GPUs needed for fine-tuning to be determined. The estimation engine 130 may identify a recommended configuration and the estimated configuration will be presented to a user for approval. If approved, an instance of service may be created to start the training process.

The estimation engine 130, aspects of which may themselves be embodied as a machine learning model, can determine the numbers of tokens from the dataset, the number of parameters to be trained, the time needed for training the model, and the best model for the specific application or use case.

The estimation engine 130 may also orchestrate the training process. Embodiments of the invention may determine how computations resources can be efficiently used to avoid using GPUs and CPUs inefficiently. This allows more training processes to be instantiated for more users.

Embodiments of the invention also eliminate or reduce the need for expert knowledge. More specifically, there are various parameters to be configured before training a model. This may present a learning curve that may affect the extensive use of models such as LLMs. Embodiments of the invention eliminate the configuration step for the user, which allows the user to focus on the quality of the user's dataset or other concerns related to training.

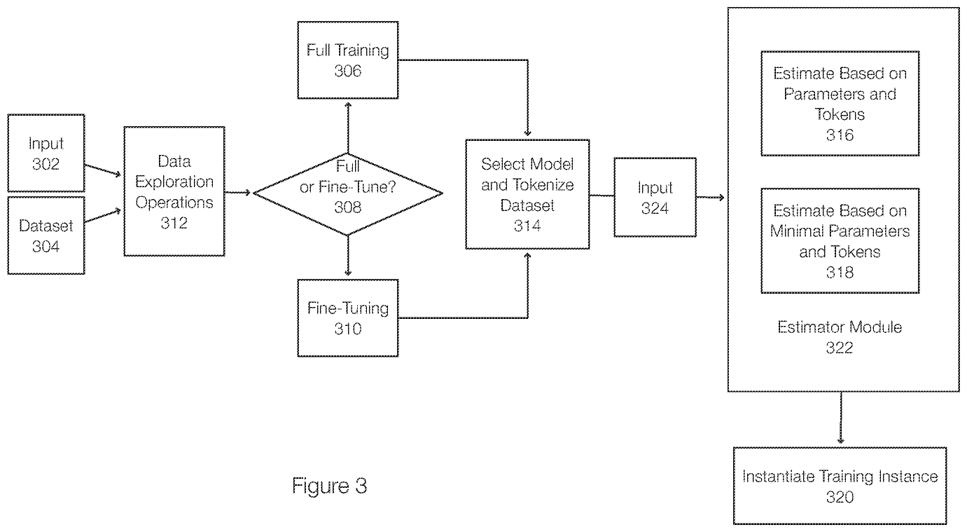

FIG. 3 discloses aspects of estimating resources required, time, and cost of training a model. In one example, an estimator engine may receive input 302 and a dataset 304. The input 302 may include, as previously stated, an intended task or use case and whether full training (306) or fine-tuning training (308) is being requested. In either case, data exploration operations 312 may be performed prior to performing tuning operations. The data exploration operations 312 may include dataset augmentation operations, data cleaning operations, or the like. In some examples, data exploration operations 312 may be omitted.

In this example, the input 302 identifies whether full training 306 or fine-tuning 310 is to be performed.

In this example, after the type of training is selected, the exploration phase is completed and the model identification phase begins. Thus, a model is selected and the dataset is tokenized 314. In the model identification phase, the input 302 may be used to select a model from a database or to recommend a model for the use or application proposed or desired by the user submitting the dataset.

Once the model is identified and metadata is received, the estimation phase begins. This may be performed by an estimator module 322 of the estimator engine. The methods or operations performed to generate an estimate (e.g., of computing resources, cost, time) may depend on whether fine-tuning 310 or full training 306 was selected.

More specifically, an input 324 to the estimator module 322 may include a tokenized dataset, model metadata, and model weights. The estimator module may generate an estimate 318 based on minimal (or reduced) parameters and tokens. As previously stated, LoRA may be used to reduce the number of parameters needed for training while maintaining the performance of the model with regard to the specified task or use case. Other approaches, such as few-shot parameter-efficient fine-tuning may also be used. The estimator module 322, in the context of fine-tuning 310, may be configured to reduce the number of parameters. Fine-tuning may also be performed without reducing the number of parameters.

Once the parameters have been reduced in number, the computational resources, time, and cost are estimated using the number of tokens (previously obtained) and the number of parameters to be tuned after reduction.

The time required for end-to-end training on T tokens may be expressed as follows:

$$End - to - end training time \approx \frac{8 TP}{nX} . \qquad Equation ( 1 )$$

In this example, T is the number of tokens, P is the number of parameters, n is the number of GPUs, and X is flops/seconds.

For example, if the GPT-3 model is selected, the estimate may be generated as follows. The GPT-3 model has P=175 billion parameters. In one example, the number of tokens used in training is T=300 billion tokens, the number of GPUs is n=1024 A100 GPUS, and a batch size 1536. The achieved flops/seconds was X=140 tera FLOP/s per GPU. As a result, the time required to train is:

$$End - to - end training time \approx \frac{8 x 175 x {10}^{9} x 300 x {10}^{9}}{1024 x 140 x {10}^{12}} seconds \approx 34 days$$

From Equation 1, the number of GPUs can be varied, which directly impacts the flops/second. The batch size is also a relevant value and can be modified by trying to increase the throughput of flop/seconds value.

By varying these values, estimates of time, computation resources (e.g., GPUs) and cost (which may be based on number of GPUs used, flops/second, or other metric) are determined and can be presented to a user for approval. When an estimate is approved, a training instance may be instantiated 320 and the model may be trained (or fine-tune) using the dataset. This further allows a user to adapt to their circumstance. A user, for example, may be able to reduce the estimated time by increasing the computational resources and cost.

This also allows the provider (e.g., the entity or service that may perform the training in their computing resources) to plan for other customers or other training requests. Training operations that are not time sensitive, for example, may be moved to CPU to free GPU for other more time-sensitive training operations. The recommendation can be optimized based on a user's requirements, the provider's resources, or the like. In one example, GPU memory may be reserved for CUDA kernels and may be accounted for in the estimate. A different estimate is based 316 on parameters and tokens without any attempt to reduce the number of parameters. The same equation (1) can be used.

While training a model from the beginning (e.g., full training 306) is resource intensive and time consuming, embodiments of the invention allow for full training to be performed. Generally, the memory required for training a model can be categorized into two components: (i) model states that include optimizer states, gradients, and model parameters, and (ii) residual states that refers to activation memory.

In one example, mixed precision training may be employed and this type of training consumed 20 bytes of memory per parameter by applying the Adam optimizer as follows:

$${\underbrace{2 + 4}}_{weights} + {\underbrace{2 + 4}}_{gradient} + {\underbrace{4 + 4}}_{Adam states} = 20 bytes .$$

The num of parameters in a model, P, may be computed as follows:

$$P = 12 l {h}^{2} ( 1 + \frac{13}{12 h} + \frac{V + s e q}{12 l h} )$$

In this example:
h: hidden layer dimension,
l: number of transformer layers,
V: vocabulary size, and
seq: sequence length.

The terms can be explained as follows:

$$P = {\underbrace{{\underbrace{12 {lxh}^{2}}}_{model state} + 13 lxh}}_{layer} + {\underbrace{hxV + hxseq}}_{embedding}$$

Activations can also consume significant memory and scale with the training batch size, sequence length, and model dimension. The memory required to store activation checkpoints (“ci”) is estimated as:

$$2 bytes \times batch - size \times seq \times h \times l / ci .$$

Activation memory can be mitigated by virtue of gradient accumulation. This can reduce the memory in factor of micro-batches (micro-“batch-size”). For instance, in Smith, Shaden, et al. “Using deepspeed and megatron to train megatron-turing nlg 530b, a large-scale generative language model.” arXiv preprint arXiv: 2201.11990 (2022), an example is detailed as follows.

Training with 1920 micro-batches reduces the peak activation memory from 16.9 terabytes to 8.8 gigabytes without changing the effective batch size:

$$8.8 G B = \frac{16.9 T B}{1920} .$$

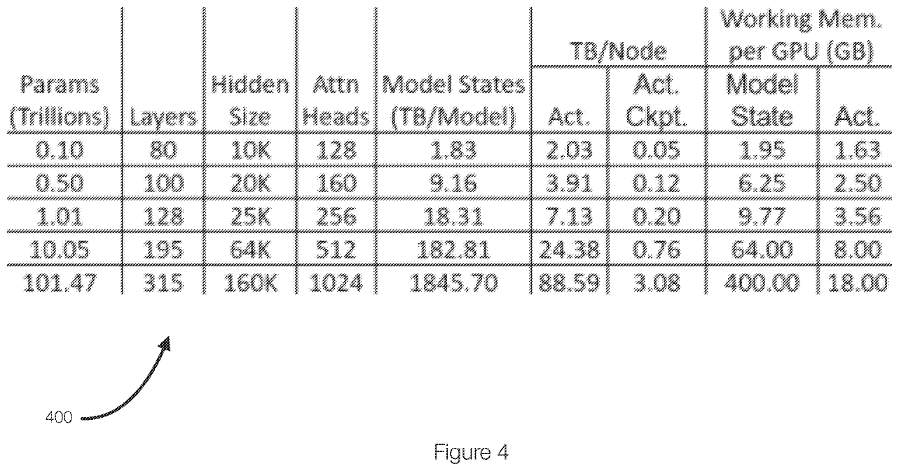

For instance, given 530 billion parameters, such as in Megatron, the memory can be estimated, considering the parameters in row two from the table 400 illustrated in FIG. 4 as follows:

$${\underbrace{960 G B}}_{model states} + {\underbrace{120 G B}}_{activation memory} + {\underbrace{10 G B}}_{MSWM + AWM} = 1090 G B .$$

In this example, a minimum of 14×80 GB A100 GPUs are needed to avoid out of GPU memory errors or problems.

Model State Working Memory (MSWM) is the minimum amount of GPU memory required to perform forward or backward propagation on the largest single operator in the model after all the model states have been offloaded to CPU or Non-Volatile Memory Express (NVMe).

Activation Working Memory (AWM) is the memory required in the backward propagation for recomputing the activations before performing the actual backward propagation.

Equation 1 can be used to determine how to accelerate the training process. In one example, increasing the number of GPUs will accelerate the training process. Accelerating the training process reduces the time of end-to-end training.

Various tools may exist to aid in reducing the training time by scaling the process and compressing the weights of the model. However, these tools have many parameters that should be selected and configured prior to training. For example, if speed is not a priority, Deedspeed (e.g., DeepSpeed library: https://github.com/microsoft/DeepSpeed) can offload to the CPU to reduce the GPU memory required.

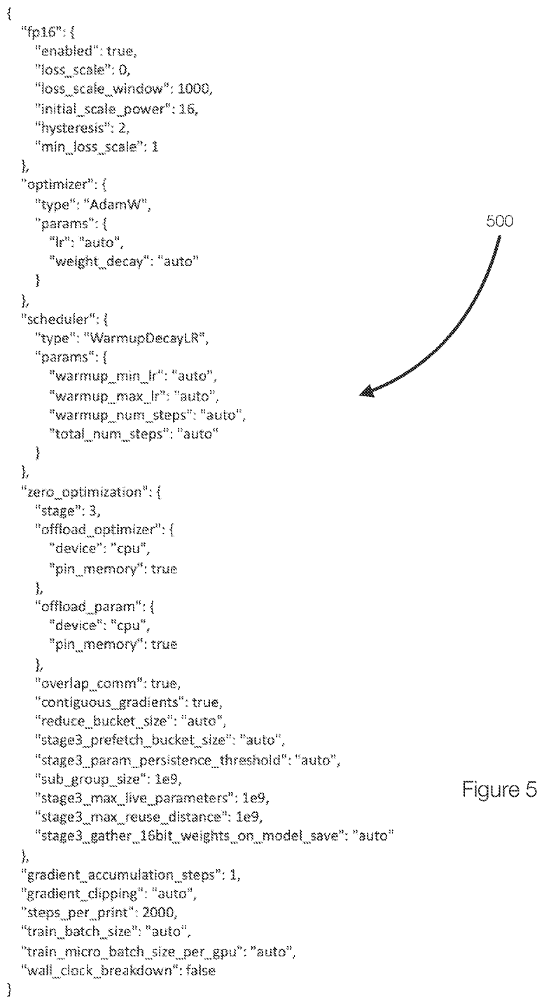

FIG. 5 discloses aspects of a library that allows a tool such as Deedspeed to be automatically configured. The dictionary 500 illustrates an example dictionary for configuring this tool. The fields are explained in https://www.deepspeed.ai/docs/config-json/.

However, some of the fields include:
fp16: Defines if mixed-precision [4] is going to be used for training or not. It's important to note that mixed-precision is only going to speed up model's on most recent GPUS;
zero_optimization stage: Defines which stage of DeepSpeed is going to be employed. Stage 1 partitions only the optimizer states, Stage 2 also partitions the gradients, and Stage 3 also partitions the model's parameters and offloading the CPU cores; and
gradient_accumulation_steps: Defines the technique of gradient accumulation, which helps to reduce memory by accumulating multiple gradients before performing the backward pass.

In normal model training, the user may be required to learn each parameter and learn the significance of each parameter. This learning curve can adversely impact the process of training the model. Embodiments of the invention are configured to select and/or recommend a configuration of these parameters automatically such that time required to learn and test the parameters is avoided.

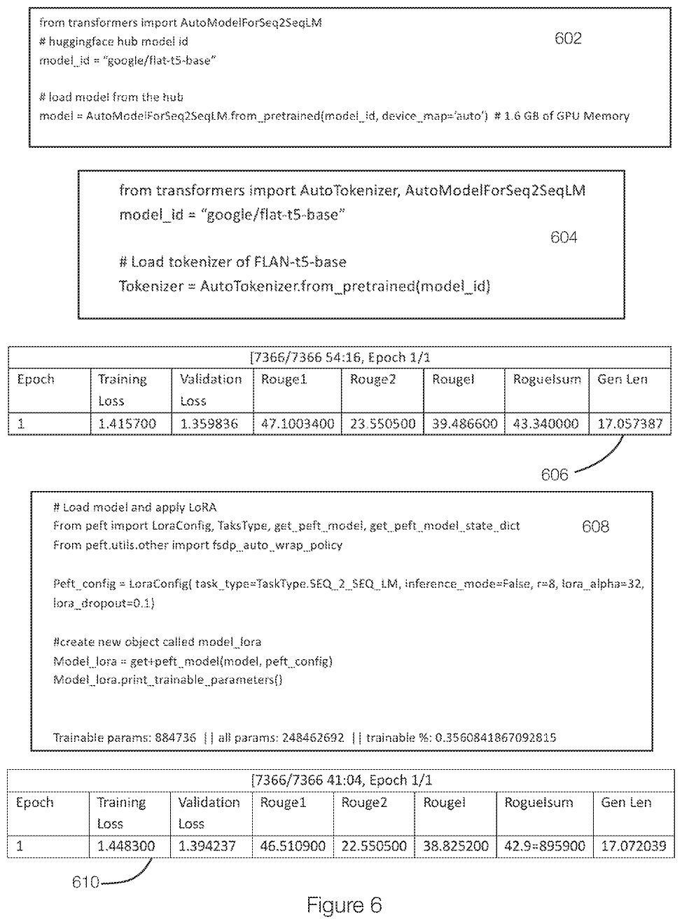

FIG. 6 discloses aspects of experiments related to training a machine learning model. In this example, the setup configuration included two GPUs Tesla V100 with 32 GB of VRAM in each GPU.

In block 602, example code or pseudocode is illustrated. The example code is configured to load a model (e.g., flan-t5-base). This model includes ˜247 million parameters and can be applied in several natural language processing tasks. The recommended use for this model is text summarization. The memory consumption starts with 1.6 GB. This memory is estimated as follows:
Number of trainable parameters from google/flan-t5-base: 246577856;
GPU memory in GP, fp32: 347577856*3*10**-9=0.990311424 GiB. The difference between 1.6 GiB and 0.9903 GiB is consumed by CUDA Kernels.

In this example, the samsum dataset (https://huggingface.co/datasets/samsum) is used. The samsum dataset is a collection of about 16 K messenger-like conversations with summaries. The conversations were created and written by linguists fluent in English.

In block 604, example code or pseudocode is illustrated that is configured to load a tokenizer to be used with flan-t5-base. The tokenizer is loaded and the dataset may be tokenized as previously described.

After the data exploration phase and the model identification phase are completed, embodiments of the invention may perform an estimation phase. FIG. 6 illustrates aspects of full fine-tuning (no parameter reduction) and aspects of fine-tuning with reduced parameters (e.g., using LoRA).

A first test is to train the model without LoRA and collect the telemetry. In this example, the max source length of the input model is 512 and the max target length of the output model is 95. The batch size is 2, the learning rate 5e-5 and the number of epochs is 1. The seq2seqTrainer method is used to create an instance of a training object that encapsulates the model.

While training the model, 6571 MiB was allocated in GPU VRAM. After finishing the training, the memory was 6691 MiB. The log 606 illustrates the calculated metrics and the execution time for 1 epoch.

A second test, using the same parameters for training, was performed. In this test, however, LoRA was used to reduce the number of parameters of the model to be tuned.

The code 608 (or pseudocode) may be used to create the LoRA model. As illustrated, using LoRA reduces the parameters to be tuned to 884736, which is 0.35% of the total parameters. During training, 4093 MiB was allocated, and it is expected that 17.5 MiB will be consumed by these parameters. This approach avoids exploding the memory activation checkpoint. Plus, the gradients from the frozen parameters are not estimated. The rest of the model is loaded in the GPU that consumes part of the memory. The log 610 illustrates the calculated metrics and the execution time for 1 epoch.

In these example tests, the training time decreased from 54 minutes to 41 minutes due to reducing the number of parameters. Although the metrics in the log 610 are lower, this can be improved by increasing the epochs. Using LoRA also demonstrated that the memory consumption was reduced. The memory allocated when using LoRA was 4093 MiB compared to 6571 MiB without LoRA. The telemetry data can be used to improve the estimations of the estimating engine.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, data exploration operations, model identification operations, estimation operations, parameter reduction operations, time, cost and resource estimation operations, training operations inference operations, or the like or combinations thereof. More generally, the scope of the invention embraces any operating environment in which the disclosed concepts may be useful.

New and/or modified data collected and/or generated in connection with some embodiments, may be stored in a data environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform services and data related operations.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers, clients, for example, may likewise take the form of software, physical machines, containers, or virtual machines (VM), though no particular component implementation is required for any embodiment.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a dataset in preparation for performing a training operation, performing a model identification phase by identifying a model to be trained using the dataset, estimating at least computing resources and time required to train the identified model using the dataset, and training the identified model with the dataset.

Embodiment 2. The method of embodiment 1, further comprising performing a data exploration phase to prepare the dataset for training the identified model, wherein the data exploration phase includes cleaning the dataset and/or augmenting the dataset.

Embodiment 3. The method of embodiment 1 and/or 2, further comprising receiving the dataset from a user and receiving a use case from the user, wherein the model identification phase identifies the model based at least on the use case.

Embodiment 4. The method of embodiment 1, 2, and/or 3, wherein the identified model is associated with model metadata and model weights, wherein the model metadata includes at least one of a number of hidden layers, a historical batch size, model size, recommended task, and a tokenizer associated with the model.

Embodiment 5. The method of embodiment 1, 2, 3, and/or 4, further comprising tokenizing the dataset using the tokenizer.

Embodiment 6. The method of embodiment 1, 2, 3, 4, and/or 5, further comprising determining whether to perform a full fine tuning of the model or an optimized fine-tuning of the model.

Embodiment 7. The method of embodiment 1, 2, 3, 4, 5, and/or 6, further comprising reducing a number of parameters of the identified model for training prior to training the model when performing an optimized fine-tuning.

Embodiment 8. The method of embodiment 1, 2, 3, 4, 5, 6, and/or 7, further comprising estimating the time and computing resources based on a relationship of:

$$End - to - end training time \approx \frac{8 TP}{nX} , \qquad Equation ( 1 )$$

wherein T is the number of tokens, P is the number of parameters, n is the number of graphical processing units, and X is flops/seconds.

Embodiment 9. The method of embodiment 1, 2, 3, 4, 5, 6, 7, and/or 8, further comprising adjusting the number of graphical processing units to change the estimated time and/or computing resources and estimating a cost based on the time and/or the number of graphical processing units.

Embodiment 10. The method of embodiment 1, 2, 3, 4, 5, 6, 7, 8, 9, and/or 9, further comprising instantiating a training instance once a recommended estimate is approved by a user.

Embodiment 11. The method of embodiment 1, 2, 3, 4, 5, 6, 7, 8, 9, and/or 10, further comprising estimating the computing resources for the full fine-tuning based on model state, activation memory and model state working memory when training the model, wherein the model is not pre-trained.

Embodiment 12. The method of embodiment 1, 2, 3, 4, 5, 6, 7, 8, 9, 10, and/or 11, further comprising automatically configuring parameters of the training operation without user input.

Embodiment 13. The method as recited in any of embodiments 1-12 or any combination thereof.

Embodiment 14 A system, comprising hardware and/or software, operable to perform any of the operations, methods, or processes, or any portion of any of these, disclosed herein.

Embodiment 15 A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term component, module, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

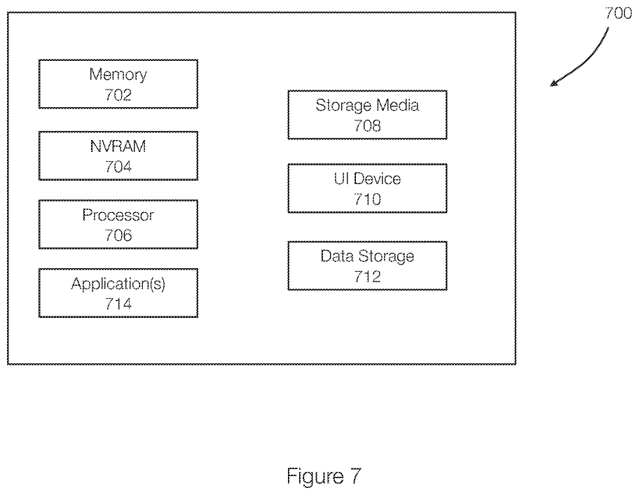

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a dataset in preparation for performing a training operation;
performing a model identification phase by identifying a model to be trained using the dataset;
estimating at least computing resources and time required to train the identified model using the dataset; and
training the identified model with the dataset.

2. The method of claim 1, further comprising performing a data exploration phase to prepare the dataset for training the identified model, wherein the data exploration phase includes cleaning the dataset and/or augmenting the dataset.

3. The method of claim 1, further comprising receiving the dataset from a user and receiving a use case from the user, wherein the model identification phase identifies the model based at least on the use case.

4. The method of claim 3, wherein the identified model is associated with model metadata and model weights, wherein the model metadata includes at least one of a number of hidden layers, a historical batch size, model size, recommended task, and a tokenizer associated with the model.

5. The method of claim 4, further comprising tokenizing the dataset using the tokenizer.

6. The method of claim 5, further comprising determining whether to perform a full fine tuning of the model or an optimized fine-tuning of the model.

7. The method of claim 6, further comprising reducing a number of parameters of the identified model for training prior to training the model when performing an optimized fine-tuning.

8. The method of claim 7, further comprising estimating the time and computing resources based on a relationship of:
$$End - to - end training time \approx \frac{8 TP}{nX} ,$$
wherein T is the number of tokens, P is the number of parameters, n is the number of graphical processing units, and X is flops/seconds.

9. The method of claim 8, further comprising adjusting the number of graphical processing units to change the estimated time and/or computing resources and estimating a cost based on the time and/or the number of graphical processing units.

10. The method of claim 9, further comprising instantiating a training instance once a recommended estimate is approved by a user.

11. The method of claim 6, further comprising estimating the computing resources for the full fine-tuning based on model state, activation memory and model state working memory when training the model, wherein the model is not pre-trained.

12. The method of claim 1, further comprising automatically configuring parameters of the training operation without user input.

13. A non-transitory storage medium having stored therein instructions that are executable by one or more hardware processors to perform operations comprising:
receiving a dataset in preparation for performing a training operation;
performing a model identification phase by identifying a model to be trained using the dataset;
estimating at least computing resources and time required to train the identified model using the dataset; and
training the identified model with the dataset.

14. The method of claim 13, further comprising performing a data exploration phase to prepare the dataset for training the identified model, wherein the data exploration phase includes cleaning the dataset and/or augmenting the dataset, further comprising receiving the dataset from a user and receiving a use case from the user, wherein the model identification phase identifies the model based at least on the use case.

15. The method of claim 14, wherein the identified model is associated with model metadata and model weights, wherein the model metadata includes at least one of a number of hidden layers, a historical batch size, model size, recommended task, and a tokenizer associated with the model, further comprising tokenizing the dataset using the tokenizer.

16. The method of claim 15, further comprising determining whether to perform a full fine tuning of the model or an optimized fine-tuning of the model.

17. The method of claim 16, further comprising:
reducing a number of parameters of the identified model for training prior to training the model when performing an optimized fine-tuning; and
estimating the time and computing resources based on a relationship of:
$$End - to - end training time \approx \frac{8 TP}{nX} ,$$
wherein T is the number of tokens, P is the number of parameters, n is the number of graphical processing units, and X is flops/seconds.

18. The method of claim 17, further comprising adjusting the number of graphical processing units to change the estimated time and/or computing resources and estimating a cost based on the time and/or the number of graphical processing units and instantiating a training instance once a recommended estimate is approved by a user.

19. The method of claim 16, further comprising estimating the computing resources for the full fine-tuning based on model state, activation memory and model state working memory when training the model, wherein the model is not pre-trained.

20. The method of claim 13, further comprising automatically configuring parameters of the training operation without user input.
